(19) United States
(12) Patent Application Publication
(10) Pub. No.: US 2024/0079672 A1
(43) Pub. Date: Mar. 7, 2024

(54) FUSIBLE THERMAL INTERFACE MATERIALS FOR USE WITHIN TRACTION BATTERY PACKS

(71) Applicant: FORD GLOBAL TECHNOLOGIES, LLC, Dearborn, MI (US)

(72) Inventors: Mohammadreza EFEKHARI, Novi, MI (US); George Albert GARFINKEL, Westland, MI (US); Daniel Benjamin KOK, Ann Arbor, MI (US); Suman MISHRA, Canton, MI (US)

(21) Appl. No.: 18/162,944

(22) Filed: Feb. 1, 2023

Related U.S. Application Data
(60) Provisional application No. 63/403,445, filed on Sep. 2, 2022.

(51) Int. Cl. H01M 10/653; B60L 50/64; B60L 58/24; H01M 10/613; H01M 10/625; H01M 10/6554; H01M 10/658; H01M 50/211

(52) U.S. Cl. CPC H01M 10/653; B60L 50/64; B60L 58/24; H01M 10/613; H01M 10/625; H01M 10/6554; H01M 10/658; H01M 50/211; H01M 2220/20

(57) ABSTRACT

Fusible thermal interface materials are provided for traction battery packs. An exemplary fusible thermal interface material may be disposed between a grouping of battery cells and a heat exchanger plate for limiting the transfer of thermal energy associated with a battery thermal event from moving from cell-to-cell and/or compartment-to-compartment within the traction battery pack. The fusible thermal interface material may be configured to transition from a conductor to an insulator when a temperature exceeds a predefined temperature threshold.

### CROSS-REFERENCE TO RELATED APPLICATIONS

This disclosure claims priority to U.S. Provisional Application No. 63/403,445, which was filed on Sep. 2, 2022 and is incorporated herein by reference.

### TECHNICAL FIELD

This disclosure relates generally to traction battery packs, and more particularly to fusible thermal interface materials for limiting the transfer of thermal energy within traction battery packs.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A traction battery pack according to an exemplary aspect of the present disclosure includes, among other things, a plurality of battery cells arranged between a first thermal barrier assembly and a second thermal barrier assembly, a heat exchanger plate positioned adjacent to the plurality of battery cells, and a fusible thermal interface material disposed between the plurality of battery cells and the heat exchanger plate.

In a further non-limiting embodiment of the foregoing traction battery pack, the plurality of battery cells are part of a cell stack that is arranged between a first cross-member beam and a second cross-member.

In a further non-limiting embodiment of either of the foregoing traction battery packs, each of the first thermal barrier assembly and the second thermal barrier assembly includes a protective housing, a thermal insulating barrier within the protective housing, a fin, and a locator.

In a further non-limiting embodiment of any of the foregoing traction battery packs, the fin is configured to interface with an enclosure cover, and the locator is configured to interface with the heat exchanger plate.

In a further non-limiting embodiment of any of the foregoing traction battery packs, the thermal insulating barrier includes an aerogel material or a foam material.

In a further non-limiting embodiment of any of the foregoing traction battery packs, the fusible thermal interface material includes a silicone based material with an intumescent additive.

In a further non-limiting embodiment of any of the foregoing traction battery packs, the fusible thermal interface material includes a polyurethane based material with an intumescent additive.

In a further non-limiting embodiment of any of the foregoing traction battery packs, the fusible thermal interface material is configured to transition from a conductor to an insulator when a temperature within the traction battery pack exceeds a predefined temperature threshold.

In a further non-limiting embodiment of any of the foregoing traction battery packs, at least a portion of the fusible thermal interface material is configured to disintegrate to establish an insulating air gap between the plurality of battery cells and the heat exchanger plate when the temperature exceeds the predefined temperature threshold.

In a further non-limiting embodiment of any of the foregoing traction battery packs, the fusible thermal interface material is configured to expand to establish an insulating barrier between the plurality of battery cells and the heat exchanger plate when the temperature exceeds the predefined temperature threshold.

A traction battery pack according to another exemplary aspect of the present disclosure includes, among other things, a battery cell stack, a heat exchanger plate adjacent to the battery cell stack, and a fusible thermal interface material disposed between the battery cell stack and the heat exchanger plate. The fusible thermal interface material is configured to transition from exhibiting a conductive property to exhibiting an insulative property when a temperature within the traction battery pack exceeds a predefined temperature threshold.

In a further non-limiting embodiment of the foregoing traction battery pack, at least a portion of the fusible thermal interface material is configured to disintegrate to establish an insulating air gap between the battery cell stack and the heat exchanger plate when the temperature exceeds the predefined temperature threshold.

In a further non-limiting embodiment of either of the foregoing traction battery packs, the fusible thermal interface material is configured to expand to establish an insulating barrier between the battery cell stack and the heat exchanger plate when the temperature exceeds the predefined temperature threshold.

In a further non-limiting embodiment of any of the foregoing traction battery packs, the fusible thermal interface material includes a silicone based material with an intumescent additive.

In a further non-limiting embodiment of any of the foregoing traction battery packs, the fusible thermal interface material includes a polyurethane based material with an intumescent additive.

In a further non-limiting embodiment of any of the foregoing traction battery packs, a grouping of battery cells of the battery cell stack is arranged between a first thermal barrier assembly and a second thermal barrier assembly.

In a further non-limiting embodiment of any of the foregoing traction battery packs, each of the first thermal barrier assembly and the second thermal barrier assembly includes a fin that is secured to an enclosure cover of the traction battery pack with an adhesive.

In a further non-limiting embodiment of any of the foregoing traction battery packs, each of the first thermal barrier assembly and the second thermal barrier assembly includes a locator that is configured to interface with the heat exchanger plate.

In a further non-limiting embodiment of any of the foregoing traction battery packs, the locator is received within a slot of the heat exchanger plate.

In a further non-limiting embodiment of any of the foregoing traction battery packs, the fusible thermal interface material is a temperature sensitive material.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is an exploded perspective view of a traction battery pack for an electrified vehicle.

FIG. 3 is a cross-sectional view through section 3-3 of FIG. 2.

FIG. 4 illustrates an exemplary fusible thermal interface material of a traction battery pack.

FIG. 5 schematically illustrates the behavior of a fusible thermal interface material during a battery thermal event.

FIG. 6 schematically illustrates the behavior of another fusible thermal interface material during a battery thermal event.

### DETAILED DESCRIPTION

This disclosure details fusible thermal interface materials for traction battery packs. An exemplary fusible thermal interface material may be disposed between a grouping of battery cells and a heat exchanger plate for limiting the transfer of thermal energy associated with a battery thermal event from moving from cell-to-cell and/or compartment-to-compartment within the traction battery pack. The fusible thermal interface material may be configured to transition from acting as a conductor to an insulator when a temperature exceeds a predefined temperature threshold. These and other features are discussed in greater detail in the following paragraphs of this detailed description.

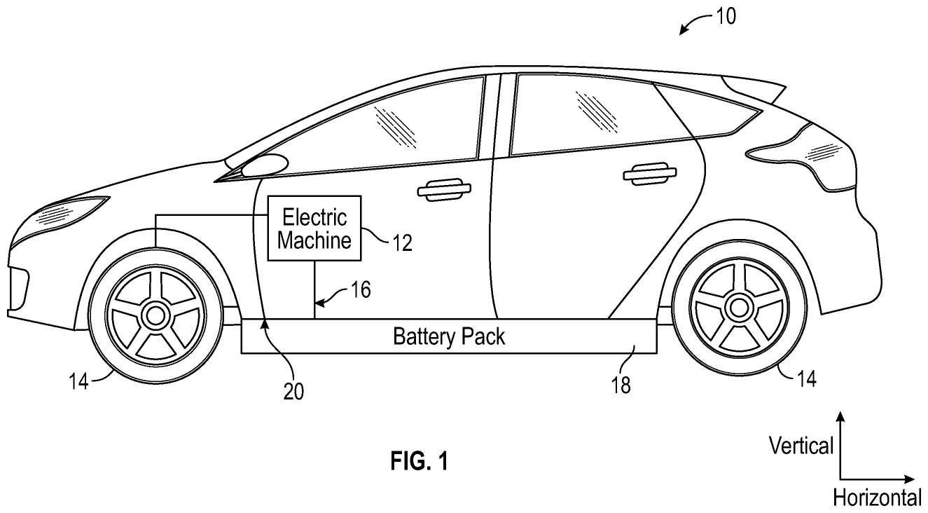

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

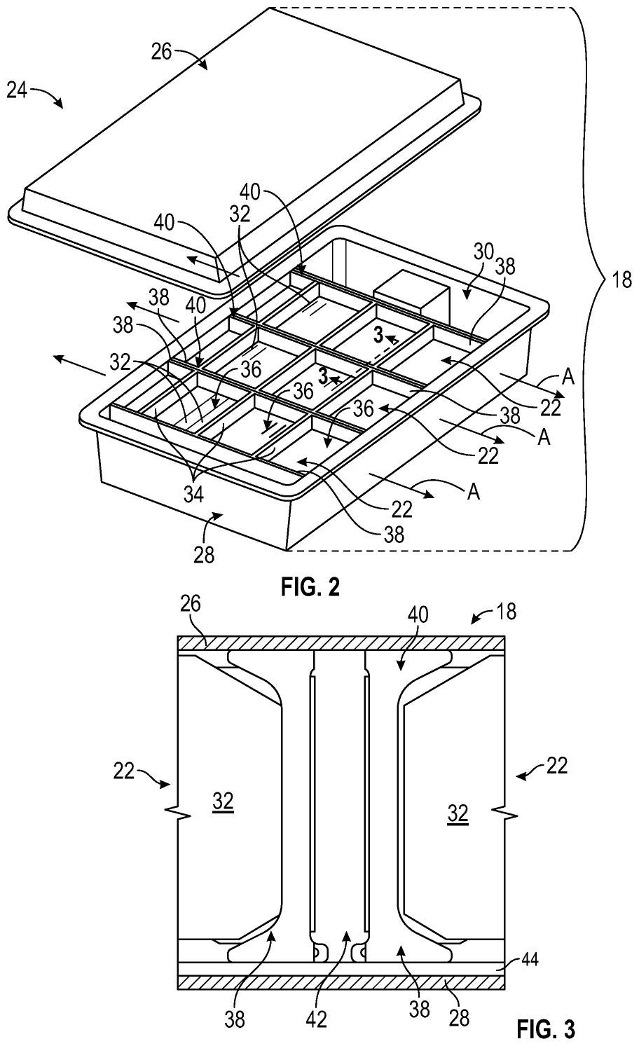

FIGS. 2 and 3 illustrate additional details associated with the traction battery pack 18 of the electrified vehicle 10. The traction battery pack 18 may include a plurality of cell stacks 22 housed within an interior area 30 of an enclosure assembly 24. The enclosure assembly 24 of the traction battery pack 18 may include an enclosure cover 26 and an enclosure tray 28. The enclosure cover 26 may be secured (e.g., bolted, welded, adhered, etc.) to the enclosure tray 28 to provide the interior area 30 for housing the cells stacks 22 and other battery internal components.

Each cell stack 22 may include a plurality of battery cells 32. The battery cells 32 of each cell stack 22 may be stacked side-by-side relative to one another along a cell stack axis A. The battery cells 32 store and supply electrical power for powering various components of the electrified vehicle 10. Although a specific number of cell stacks 22 and battery cells 32 are illustrated in the various figures of this disclosure, the traction battery pack 18 could include any number of the cell stacks 22, with each cell stack 22 having any number of individual battery cells 32.

In an embodiment, the battery cells 32 are lithium-ion pouch cells. However, battery cells having other geometries (cylindrical, prismatic, etc.) and/or chemistries (nickel-metal hydride, lead-acid, etc.) could alternatively be utilized within the scope of this disclosure. The exemplary battery cells 32 can include tab terminals extending from a battery cell housing. An aluminum film may provide the battery cell housing, for example.

The battery cells 32 of each cell stack 22 may be arranged between a pair of cross-member beams 38. The cross-member beams 38 may be configured to hold the battery cells 32 and at least partially delineate the cell stacks 22.

Immediately adjacent-cross member beams 38 may establish a cross-member assembly 40 disposed between adjacent cell stacks 22 of the traction battery pack 18. The cross-member assemblies 40 may be configured to transfer a load applied to a side of the electrified vehicle 10, for example. Each cross-member beam 38 of the cross-member assemblies 40 may be a structural beam that can help accommodate tension loads from battery cell 32 expansion and compression loads. The cross-member assemblies 40 are therefore configured to increase the structural integrity of the traction battery pack 18.

The cross-member assemblies 40 may also establish a battery pack venting system for communicating battery cell vent byproducts from the traction battery pack 18 during battery thermal events. For example, the cross-member assemblies 40 may establish passageways 42 (best shown in FIG. 3) that can communicate battery cell vent byproducts from the cell stacks 22 toward a position where the battery cell vent byproducts can be expelled from the traction battery pack 18.

In the exemplary embodiment, first and second adjacent cross-member beams 38 may establish a first side and a second side, respectively, of the passageway 42 of the cross-member assembly 40. Further, a vertically upper side of the passageway 42 may be established by the enclosure cover 26 (see FIG. 3), and a vertically lower side of the passageway 42 may be established by a heat exchanger plate 44 positioned against the enclosure tray 28 (see FIG. 3). In another embodiment, the heat exchanger plate 44 may be omitted and the vertically lower side of the passageway 42 may be established by the enclosure tray 28. Vertical and horizontal, for purposes of this disclosure, are with reference to ground and a general orientation of traction battery pack 18 when installed within the electrified vehicle 10 of FIG. 1.

Each cross-member beam 38 may include one or more openings (not shown) for communicating the battery cell vent byproducts through the beams and into the passageway 42. The openings thus provide a path for battery cell vent byproducts to move to the passageways 42 as required. Each cross-member beam 38 may additionally include one or more openings (not shown) for accommodating cell tabs of the battery cells 32.

The cross-member beams 38 may be adhesively secured to the enclosure cover 26 and to the heat exchanger plate 44 and/or enclosure tray 28. The adhesive can seal these interfaces to inhibit battery cell vent byproducts escaping the passageway 42 through these areas.

In an embodiment, the cells stacks 22, the cross-member assemblies 40, and the respective passageways 42 extend longitudinally in a cross-vehicle direction. However, other configurations and orientations are further contemplated within the scope of this disclosure.

One or more thermal barrier assemblies 34 may be arranged along the respective cell stack axis A of each cell stack 22. The thermal barrier assemblies 34 may divide or compartmentalize each cell stack 22 into two or more groupings or compartments 36 of battery cells 32. Should, for example, a battery thermal event occur in one of the cell stacks 22, the thermal barrier assemblies 34 may block or even prevent thermal energy associated with the thermal event from moving from cell-to-cell, compartment-to-compartment, and/or cell stack-to-cell stack, thereby inhibiting thermal propagation inside the traction battery pack 18 and limiting any propagation to a single compartment 36.

Each compartment 36 may hold one or more of the battery cells 32 of one of the cell stacks 22. In an embodiment, the battery cells 32 of each cell stack 22 are held within one of four compartments 36. However, other configurations, including configurations that utilize a greater or fewer number of thermal barrier assemblies 34 and compartments 36, could be used within the scope of this disclosure.

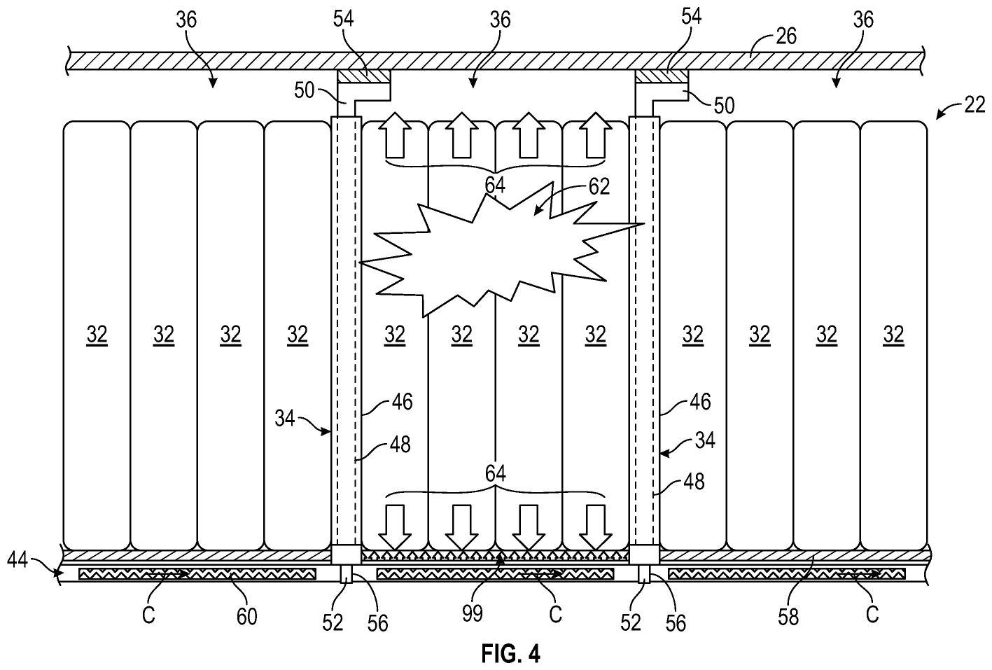

Referring to FIG. 4, each thermal barrier assembly 34 may include a protective housing 46, a thermal insulating barrier 48 within the protective housing 46, a fin 50, and a locator 52. The thermal insulating barrier 48 may be encapsulated inside the protective housing 46 and is therefore shielded by the protective housing 46.

The protective housing 46 may be made of a metallic material or a polymer composite material. In an embodiment, the protective housing 46 is made of stainless steel. However, other materials are further contemplated within the scope of this disclosure.

The thermal insulating barrier 48 may possess a relatively high thermal resistance (and thus a low thermal conductivity) for slowing or even preventing thermal propagation within the traction battery pack 18. In an embodiment, the thermal insulating barrier 48 may include an aerogel material, such as a silica-based aerogel, for example. In another embodiment, the thermal insulating barrier 48 may include a foam material, such as a silicone foam, for example. However, other material or combinations of materials could with utilized to construct the thermal insulating barrier 48 within the scope of this disclosure.

The fin 50 may be made of a metallic or polymer composite material. In an embodiment, the fin 50 is made of stainless steel. In another embodiment, the fin 50 is made of aluminum. However, other materials could be utilized to construct the fin 50 within the scope of this disclosure.

The fin 50 may be integrally formed with the protective housing 46. Portions of the fin 50 may extend inside the protective housing 46, although not specifically shown in the schematic depiction of FIG. 4. In an embodiment, the fin 50 is L-shaped, although other shapes, including but not limited to T-shapes, are contemplated within the scope of this disclosure.

The fin 50 may interface with the enclosure cover 26. In an embodiment, the fin 50 is fixedly secured to the enclosure cover 26 to increase the overall rigidity of the traction battery pack 18.

An adhesive 54 may be utilized to secure the fin 50 to the enclosure cover 26. The adhesive 54 may be an epoxy based adhesive or a urethane based adhesive, for example.

The locator 52 may be disposed on an opposite end of the protective housing 46 from the fin 50. The locator 52 may be configured to interface with the heat exchanger plate 44. The heat exchanger plate 44 may include one or more slots 56 sized to receive the locator 52. In addition to acting as a locating feature for locating the thermal barrier assembly 34 relative to the heat exchanger plate 44, the locator 52 may establish a thermal break between neighboring battery cells 32 of the cell stack 22 within which the thermal barrier assembly 34 is disposed. In some implementations, the heat exchanger plate 44 may not be slotted.

In an embodiment, the locator 52 includes a T-shaped cross-section. However, other cross-sectional shapes are contemplated within the scope of this disclosure.

A fusible thermal interface material 58 may be disposed between the battery cells 32 of one or more of the cell stacks 22 and the heat exchanger plate 44. In an embodiment, downwardly facing bottom surfaces of the battery cells 32 are in direct contact with the fusible thermal interface material 58. However, other configurations are contemplated within the scope of this disclosure.

In an embodiment, the fusible thermal interface material 58 includes a polymer based material such as silicone, polyurethane, or epoxy based material with thermally conductive elements and intumescent additives which activate at elevated temperatures. In another embodiment, the fusible thermal interface material 58 includes a polyurethane based material with intumescent additives. Other materials or combinations of materials may alternatively or additionally make up the fusible thermal interface material 58.

During normal operating conditions of the traction battery pack 18 (e.g., temperature in the rage of −30° C. to 80° C.), the fusible thermal interface material 58 may be configured to maintain thermal contact between the battery cells 32 and the heat exchanger plate 44, thereby facilitating thermal conductivity between these neighboring components during heat transfer events. Heat conducted from the battery cells 32 to the heat exchanger plate 44 may then be carried away from the battery cells 32 by a coolant C that is circulated within an internal coolant circuit 60 of the heat exchanger plate 44. In the cross-sectional view of FIG. 4, the internal coolant circuit 60 is configured such that the coolant C flows into and out of the page. However, other configurations are contemplated within the scope of this disclosure.

The fusible thermal interface material 58 may be configured to prevent the battery cells 32 from transferring a relatively large amount of thermal energy 64 (e.g., heat) into the heat exchanger plate 44 during a battery thermal event (schematically illustrated at reference numeral 62). For example, the fusible thermal interface material 58 may be configured as a temperature sensitive material. Therefore, when the temperature within the traction battery pack 18 exceeds a predefined temperature threshold (e.g., about 100° C.), the fusible thermal interface material 58 may be configured to transition from a conductor to an insulator, thereby substantially preventing the transfer of the thermal energy 64 into the heat exchanger plate 44 from the battery cells 32 that are experiencing the thermal event, and hindering cell-to-cell, compartment-to-compartment, and/or cell stack-to-cell stack propagation of the thermal energy 64. The transition of the fusible thermal interface material 58 from acting as a conductor to an insulator is schematically shown at reference numeral 99 in FIG. 4.

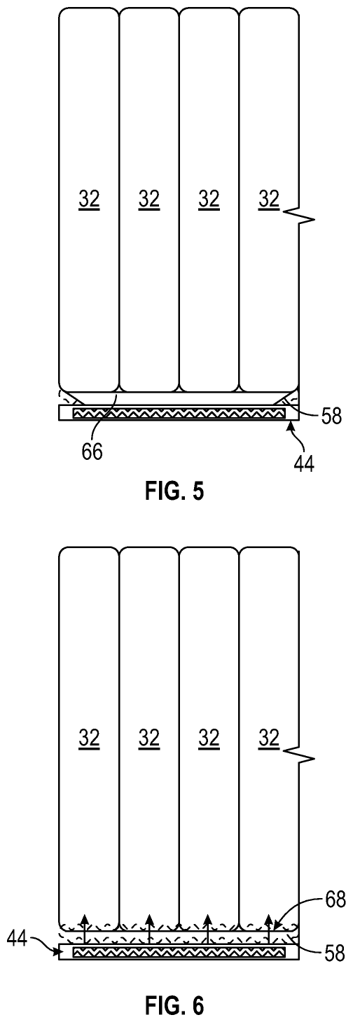

The transition of the fusible thermal interface material 58 from exhibiting conductive properties to exhibiting insulative properties may be achieved in a variety of ways. In an embodiment, schematically illustrated in FIG. 5, portions of the fusible thermal interface material 58 that are near the battery cells 32 that are experiencing the battery thermal event may be configured to disintegrate when the temperature within the traction battery pack 18 exceeds the predefined temperature threshold. The disintegrated portions of the fusible thermal interface material 58 may establish an insulating air gap 66 between the battery cells 32 and the heat exchanger plate 44. The insulating air gap 66 substantially reduces the transfer of thermal energy from the battery cells 32 into the heat exchanger plate 44.

In another embodiment, schematically illustrated in FIG. 6, at least portion of the fusible thermal interface material 58 may transition from acting as a conductor to acting as an insulator by expanding during a battery thermal event. For example, the fusible thermal interface material 58 may include intumescent additives that may expand to form an insulating barrier 68 between the battery cells 32 and the heat exchanger plate 44 when the temperature within the traction battery pack 18 exceeds the predefined temperature threshold. The insulating barrier 68 substantially reduces the transfer of thermal energy from the battery cells 32 into the heat exchanger plate 44.

The exemplary traction battery packs of this disclosure include fusible thermal interface materials. The systems may provide numerous advantages over known solutions, including but not limited to presenting a novel configuration that significantly slows or even prevents the transfer of thermal energy into a heat exchanger plate during battery thermal events.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a plurality of battery cells arranged between a first thermal barrier assembly and a second thermal barrier assembly;
a heat exchanger plate positioned adjacent to the plurality of battery cells; and
a fusible thermal interface material disposed between the plurality of battery cells and the heat exchanger plate.

2. The traction battery pack as recited in claim 1, wherein the plurality of battery cells are part of a cell stack that is arranged between a first cross-member beam and a second cross-member.

3. The traction battery pack as recited in claim 1, wherein each of the first thermal barrier assembly and the second thermal barrier assembly includes a protective housing, a thermal insulating barrier within the protective housing, a fin, and a locator.

4. The traction battery pack as recited in claim 3, wherein the fin is configured to interface with an enclosure cover and the locator is configured to interface with the heat exchanger plate.

5. The traction battery pack as recited in claim 3, wherein the thermal insulating barrier includes an aerogel material or a foam material.

6. The traction battery pack as recited in claim 1, wherein the fusible thermal interface material includes a silicone based material with an intumescent additive.

7. The traction battery pack as recited in claim 1, wherein the fusible thermal interface material includes a polyurethane based material with an intumescent additive.

8. The traction battery pack as recited in claim 1, wherein the fusible thermal interface material is configured to transition from a conductor to an insulator when a temperature within the traction battery pack exceeds a predefined temperature threshold.

9. The traction battery pack as recited in claim 8, wherein at least a portion of the fusible thermal interface material is configured to disintegrate to establish an insulating air gap between the plurality of battery cells and the heat exchanger plate when the temperature exceeds the predefined temperature threshold.

10. The traction battery pack as recited in claim 8, wherein the fusible thermal interface material is configured to expand to establish an insulating barrier between the plurality of battery cells and the heat exchanger plate when the temperature exceeds the predefined temperature threshold.

11. A traction battery pack, comprising:
a battery cell stack;
a heat exchanger plate adjacent to the battery cell stack; and
a fusible thermal interface material disposed between the battery cell stack and the heat exchanger plate,
wherein the fusible thermal interface material is configured to transition from exhibiting a conductive property to exhibiting an insulative property when a temperature within the traction battery pack exceeds a predefined temperature threshold.

12. The traction battery pack as recited in claim 11, wherein at least a portion of the fusible thermal interface material is configured to disintegrate to establish an insulating air gap between the battery cell stack and the heat exchanger plate when the temperature exceeds the predefined temperature threshold.

13. The traction battery pack as recited in claim 11, wherein the fusible thermal interface material is configured to expand to establish an insulating barrier between the battery cell stack and the heat exchanger plate when the temperature exceeds the predefined temperature threshold.

14. The traction battery pack as recited in claim 11, wherein the fusible thermal interface material includes a silicone based material with an intumescent additive.

15. The traction battery pack as recited in claim 11, wherein the fusible thermal interface material includes a polyurethane based material with an intumescent additive.

16. The traction battery pack as recited in claim 11, wherein a grouping of battery cells of the battery cell stack is arranged between a first thermal barrier assembly and a second thermal barrier assembly.

17. The traction battery pack as recited in claim 16, wherein each of the first thermal barrier assembly and the second thermal barrier assembly includes a fin that is secured to an enclosure cover of the traction battery pack with an adhesive.

18. The traction battery pack as recited in claim 16, wherein each of the first thermal barrier assembly and the second thermal barrier assembly includes a locator that is configured to interface with the heat exchanger plate.

19. The traction battery pack as recited in claim 18, wherein the locator is received within a slot of the heat exchanger plate.

20. The traction battery pack as recited in claim 11, wherein the fusible thermal interface material is a temperature sensitive material.
